(19) United States
(12) Patent Application Publication
(10) Pub. No.: US 2013/0263164 A1
(43) Pub. Date: Oct. 3, 2013

(54) ELECTRONIC DEVICE WITH SAFETY SHUTDOWN DEVICE

(71) Applicants: TING-TING ZHAO, Shenzhen (CN); HE-LI WANG, Shenzhen (CN)

(72) Inventors: TING-TING ZHAO, Shenzhen (CN); HE-LI WANG, Shenzhen (CN)

(21) Appl. No.: 13/680,130

(22) Filed: Nov. 19, 2012

(30) Foreign Application Priority Data
Mar. 29, 2012 (CN) 201220124358.1

(51) Int. Cl. G11B 19/20

(52) U.S. Cl. CPC G11B 19/2063
USPC 720/652

(57) ABSTRACT

An electronic device able to read an optical disc includes a base, a cover, a driving unit for rotating and supporting the optical disc, and a shutdown device. The shutdown device is arranged between the base and the cover, and includes a raster sensor and an engaging component. The engaging component is secured to the cover and pivots about the base. When the cover is opened, the engaging component moves away from the raster sensor, the raster sensor emits a first control signal in response, which controls the driving unit to stop rotating.

### BACKGROUND

1. Technical Field

The present disclosure relates to electronic devices with a safety shutdown device.

2. Description of Related Art

Computer disc drives are ubiquitous. An optical disc, such as Compact Disc (CD), Digital Video Disc or Digital Versatile Disc (DVD) and Mini Disc (MD) is rotated by a driving unit such as a spindle motor provided in a disc driver and the disc driver reads/writes data from/to the optical disc. The disc drives further include a base and a cover rotatably coupled to the base. In use, the optical disc is housed inside the base by closing the cover and can be removed by opening the cover. However, when the cover is opened during rotation of the optical disc, the optical disc may jump out from the base, causing damage to the optical disc.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of an embodiment of an electronic device with a shutdown device.

FIG. 2 is a partial, exploded view of the electronic device of FIG. 1.

FIG. 3 is similar to FIG. 2, but viewed from another aspect.

FIG. 4 is a partial, cross-sectional view of the electronic device of FIG. 1 in a first use state.

FIG. 5 is similar to FIG. 4, but showing another use state.

FIG. 6 is enlarged view of the shutdown device of FIG. 1 in the first use state.

FIG. 7 is similar to FIG. 6, but showing another state of use.

### DETAILED DESCRIPTION

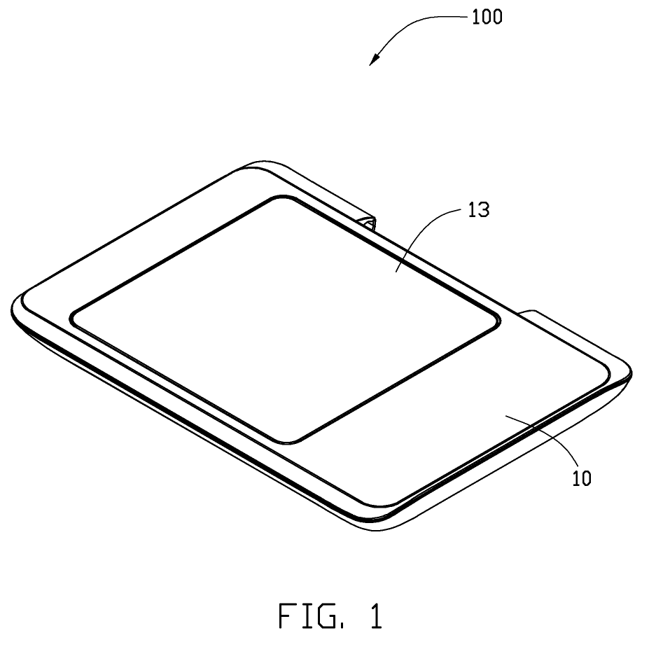

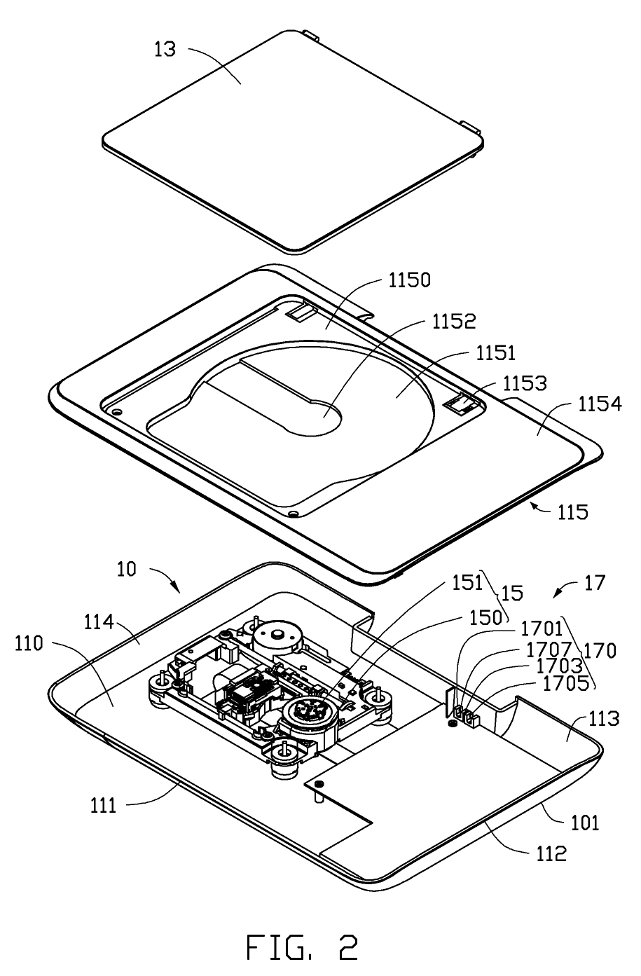

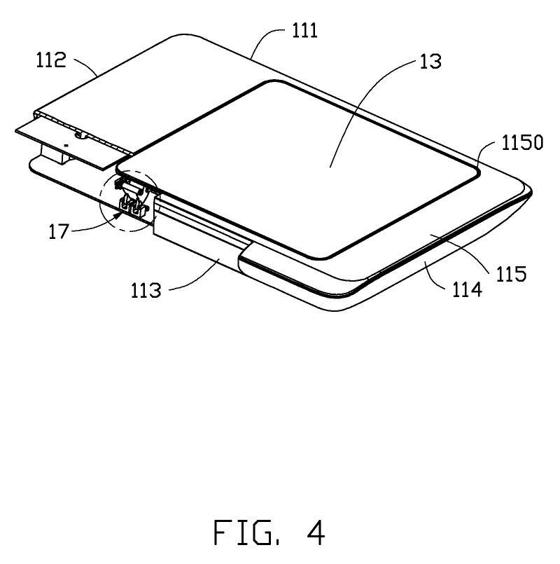

Referring to FIG. 1, an electronic device 100 of one embodiment is shown. The electronic device 100 includes a base 10, a cover 13, a driving unit 15 (shown in FIG. 2) and a shutdown device 17 (shown in FIG. 4). The driving unit 15 is received in the base 10 and rotates an optical disc (not shown). The shutdown device 17 is arranged between the base 10 and the cover 13 for controlling the driving unit 15. The electronic device 100 may be a disc drive in a notebook computer, or the like. In the embodiment, the electronic device 100 is a disc drive for retrieving data recorded on an optical disc.

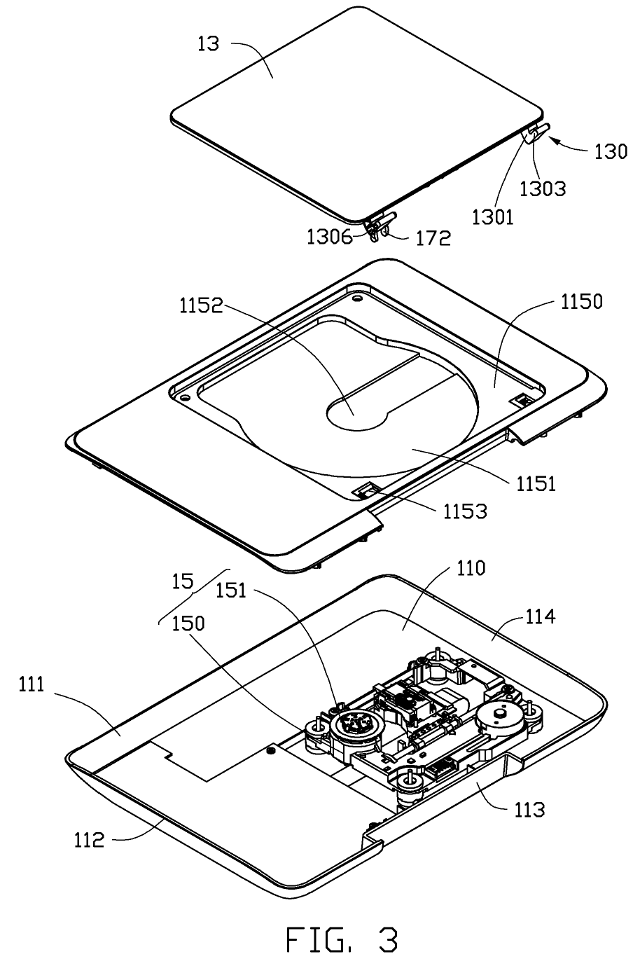

Referring to FIGS. 2 and 3, the base 10 in the embodiment is substantially rectangular. The base 10 includes a lower case 101 and an upper case 115 secured to the lower case 101. The lower case 101 cooperates with the upper case 115 to define a closed space (not labeled) for receiving components of the electronic device 100.

The lower case 101 includes a bottom wall 110, a first sidewall 111, a second sidewall 112, a third sidewall 113 opposite to the first sidewall 111, and a fourth sidewall 114 opposite to the second sidewall 112. The first, second, third and fourth sidewalls 111, 112, 113, 114 slantingly extend from four rims of the bottom wall 110 and connect with each other.

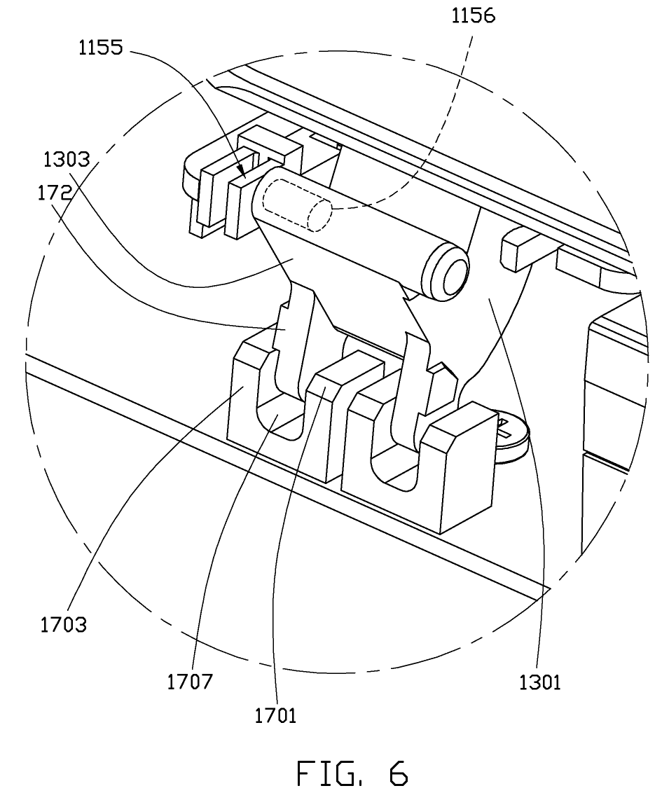

The upper case 115 includes a top surface 1154, a bottom surface (not labeled) opposite to the top surface 1154 and two connecting portions 1155 (shown in FIG. 6). The top surface 1154 is recessed to define a rectangular first receiving portion 1150 for receiving the cover 13. Two spaced through holes 1153 are defined at an edge of the first receiving portion 1150 adjacent to the third sidewall 113. The bottom of the first receiving portion 1150 further defines a substantially circular second receiving portion 1151 for receiving the optical disc. The bottom of the second receiving portion 1151 further defines a mounting hole 1152. The two connecting portions 1155 protrude from the bottom surface of the upper case 115 and are adjacent to the two through holes 1153. A shaft 1156 is secured to each opposing surface of the two connecting portions 1155 for rotatably connecting the cover 13 to the upper case 115.

The cover 13 is rotatably coupled to the base 11, to be opened and closed. The shape of the cover 13 corresponds to the shape of the first receiving portion 1150. When the cover 13 rests on the base 11, the cover 13 is received in the first receiving portion 1150.

The two hinge components 130 are secured to the cover 13 opposite to the base 11 and correspond to the two through holes 1153. Each hinge component 130 includes a first arm 1301 and a second arm 1303. The first arm 1301 projects from an outer edge of the cover 13 and is inclined away from the cover 13. The second arm 1303 is bent from an end of the first arm 1301 away from the cover 13, and is inclined toward the cover 13. Thus, from a side view, the rotating component 130 is substantially V-shaped with an opening facing the cover 13. An end of the second arm 1303 away from the first arm 1301 defines a pivoting hole 1306 for engaging with the shafts 1156.

The driving unit 15 is set on the bottom wall 110, and a part protrudes out of the bottom of the second receiving portion 1151 via the mounting hole 1152. The driving unit 15 includes a spindle motor 150 and a spindle 151 connected to the spindle motor 150. The spindle motor 150 rotates the spindle 151. The spindle 151 extends through the mounting hole 1152 and is exposed out of the upper case 115 for mounting the optical disc.

The shutdown device 17 is arranged between the bottom wall 110 and the cover 13. The shutdown device 17 includes two spaced raster sensors 170 and two engaging components 172. The two raster sensors 170 are arranged on the bottom wall 110 and correspond to one of the hinge component 130 adjacent to the second sidewall 112. Each raster sensor 170 is substantially U-shaped, and includes an emitter 1701 and a receiver 1703 opposite to the emitter 1701. A predetermined gap 1707 is formed between the emitter 1701 and the receiver 1703. Each of the emitter 1701 and the receiver 1703 defines two opposite openings 1705. The emitter 1701 transmits a infrared signal via the opening 1705, and the receiver 1703 generates a first control signal when the first infrared signal is received via the opening 1705 and generates a second control signal when a second infrared signal, different from the first infrared signal, is received. In the embodiment, since the second infrared signal can equate to no signal or to a signal with miniscule intensity, the first infrared signal is significantly stronger than the second infrared signal.

The two engaging components 172 interact with the two raster sensors 170. In the embodiment, the two engaging components 172 are two rectangular protrusion blocks. The two engaging components 172 project from the joint between the second arm 1303 and the first arm 1301 of the rotating component 130 and are opposite to the cover 13. The thickness of each engaging component 172 in a direction parallel to the third sidewall 113 is smaller than the width of the gap 1707. Thus, the engaging components 172 can be received in the corresponding gaps 1707. The size of the two engaging components 172 in a direction perpendicular to the third sidewall 113 is larger than or equal to the size of the openings 1705, such as when in front of the openings 1705 can cover or obscure the openings 1705.

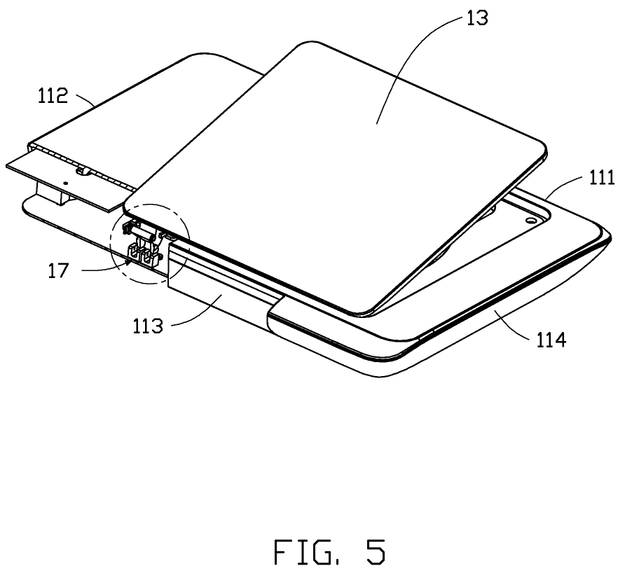

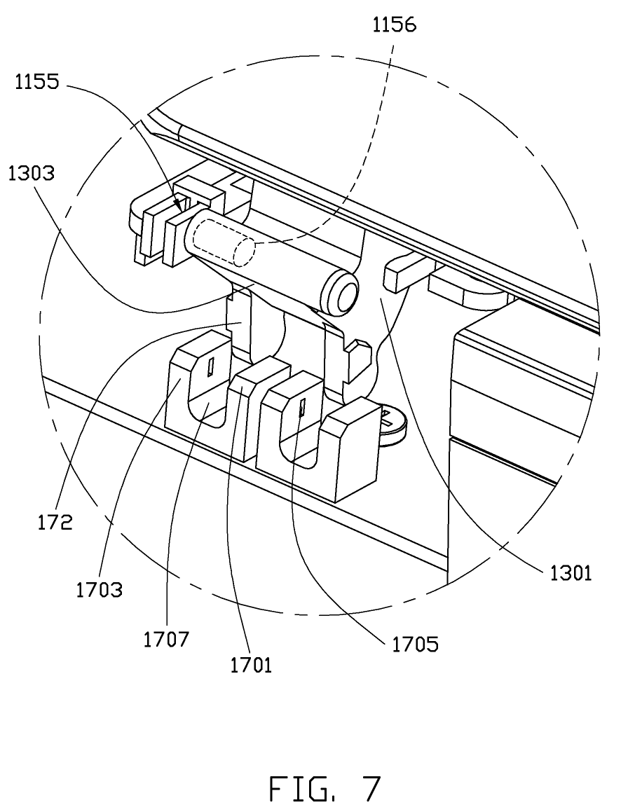

Referring to FIGS. 4, 5, 6 and 7, in assembly, the two hinge components 130 extend through the corresponding through holes 1153, with the two shafts 1156 pivotally receiving in the pivoting hole 1306, for allowing the cover 13 to be rotably coupled to the upper case 115. In this state, the cover 13 is received in the first receiving portion 1150. The engaging components 172 are received in the gaps 1707 and obscure the openings 1705. Thus, each receiver 1703 is prevented from receiving a complete or full infrared signal from an emitter 1701.

To replace/remove the optical disc after initial assembly, the cover 13 is rotated open, and the two engaging components 172 disengage from the raster sensors 170. Thus, the opening 1705 becomes open and clear, an infrared signal between each emitter 1701 and each receiver 1703 can pass. The two raster sensors 170 emit the first control signal. The driving unit 15 stops rotating in response to receiving a first control signal.

When the cover 13 is closed on the base 11, the two engaging components 172 rotate toward the raster sensors 170. The two engaging components 172 move into the corresponding gaps 1707. The infrared signal between each emitter 1701 and receiver 1703 is substantially diminished, causing the two raster sensors 170 to emit the second control signal. The driving unit 15 rotates in response to the second control signal. The electronic device 100 starts to read the data recorded on the optical disc.

In another embodiment, the number and the position of the raster sensors 170 and the engaging components 172 can be changed, such that the raster sensor 170 is arranged on the cover 13, and the engaging component 172 is arranged on the base 11.

Although information and the advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic device reproducing information recorded on an optical disc, comprising:
a base;
a cover rotatably connected to the base;
a driving unit for rotating and supporting the optical disc; and
a shutdown device arranged between the base and the cover, the shutdown device comprising:
a raster sensor secured to the base; and
an engaging component secured to the cover and capable of pivoting about the base when the cover rotates with respect to the base;
wherein when the cover is opened, the engaging component moves away from the raster sensor, and the raster sensor emits a first control signal, for controlling the driving unit to stop rotating.

2. The electronic device as claimed in claim 1, wherein when the cover is closed, the engaging component moves toward the raster sensor, the raster sensor emits a second control signal, for controlling the driving unit to rotating.

3. The electronic device as claimed in claim 1, wherein the cover comprises a hinge component, the base comprises a connecting portion engaging with the hinge component for rotatably connecting the cover to the base.

4. The electronic device as claimed in claim 3, wherein the hinge component comprises a first arm and a second arm connected to the first arm; the first arm slantingly projects from the cover, the second arm slantingly projects from an end of the first arm opposite to the cover; the engaging component protrudes from an end of the second arm connecting the first arm.

5. The electronic device as claimed in claim 2, wherein the raster sensor includes an emitter and a receiver opposite to the emitter, the emitter is capable of emitting a first infrared signal and a second infrared signal different from the first infrared signal, the receiver is capable of generating the first control signal when infrared a first infrared signal and is capable of generating the second control signal when infrared a second infrared signal from the emitter, a gap is formed between the emitter and the receiver for receiving the engaging component.

6. The electronic device as claimed in claim 5, wherein each of the emitter and the receiver defines two opposite openings, the emitter transmits the first and second infrared signal via the corresponding opening, the receiver receives the first and second infrared signal via the corresponding opening; the size of the engaging component is larger than the size of the openings, and the engaging component is capable of obscuring the openings when in front of the openings.

7. The electronic device as claimed in claim 6, wherein when the cover is closed, the engaging component moves away from the raster sensor and disengages from the openings, the raster sensor emits the first control signal to stop the driving unit rotating; when the cover is opened, the engaging component is received in the gap and obscures the openings, the raster sensor emits the second control signal to drive the driving unit to rotate.

8. The electronic device as claimed in claim 5, wherein the distance of the gap is larger than the thickness of the engaging component, for allowing the engaging component to be received in the gap.
